(19) United States
(12) Patent Application Publication
(10) Pub. No.: US 2021/0022950 A1
(43) Pub. Date: Jan. 28, 2021

(54) SYSTEM AND METHOD FOR SHOULDER AND NECK MASSAGER

(71) Applicant: TRUCORE DISTRIBUTORS, INC., Kings Park, NY (US)

(72) Inventors: MING ZHENG, Kings Park, NY (US); DARREN LISITEN, Kings Park, NY (US)

(21) Appl. No.: 16/936,370

(22) Filed: Jul. 22, 2020

Related U.S. Application Data
(60) Provisional application No. 62/877,147, filed on Jul. 22, 2019.

(51) Int. Cl. A61H 7/00

(52) U.S. Cl. CPC A61H 7/007; A61H 7/005; A61H 2205/04; A61H 2201/1654; A61H 2201/0157; A61H 2201/1215; A61H 2205/062

(57) ABSTRACT

Two groups of massage heads are arranged on a main body of the movement, each massage head group includes a first massage head and a second massage head, the movement body includes the motor, the worm on the motor driven at both ends of the turbine, each turbine transmission including a kneading gear with a shaft, the first massage head is arranged at the end of one connecting arm, the other end of the connecting arm is arranged on the shaft, and a connecting arm. The distance between two nodules and a third nodule of each of the two groups of massage heads emulates a human thumb and fingers; a cover coupled to the main body including at least two adjustable straps configured to accept human arms; and a buckle coupled to the at least two adjustable straps to enable lengthening and shortening of the at least two adjustable straps.

### CROSS REFERENCE TO RELATED APPLICATIONS

This application claims the benefit of U.S. provisional application No. 62/877,147, filed on Jul. 22, 2019, the contents of which are hereby incorporated by reference herein.

### FIELD OF INVENTION

This application is related to massage apparatus.

### SUMMARY

A neck and shoulder massage apparatus addresses the need for massagers to knead the neck and shoulders by a emulating human hands and providing adjustable arm straps. The neck and shoulder massager includes two groups of massage heads arranged on the main body of the movement, the apparatus includes a massage head group having a first massage head, which can be and a second massage head, a movement body includes a motor, a worm gear in the form a screw on the motor driven at both ends of a turbine, each turbine transmission includes a kneading gear with a shaft, the first massage head is arranged at the end of one connecting arm, the other end of the connecting arm is arranged on the shaft, and the connecting arm is provided with a strip attachment located on the main body of the movement, and the first massage head makes the composite motion of left and right and front and rear motion under the action of a coupling arm rotation and a limit nail; the second massage head is fixed on the shaft, and when the kneading gear rotates, the second massage head is rotated with kneading gear at the center.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

A more detailed understanding may be had from the following description, given by way of example in conjunction with the accompanying drawings wherein:

FIG. 1 is perspective view showing the state of the maximum distance between the first massage head and the second massage head in accordance with an embodiment;

FIG. 2 is perspective view showing the state of the minimum distance between the first massage head and the second massage head in accordance with an embodiment;

FIG. 3 is a structure decomposition of a massage unit in accordance with an embodiment;

FIG. 4 is a schematic diagram of the structure decomposition of the present invention (showing the internal installation structure of the movement body);

FIGS. 5 and 6 are schematic diagrams of the kneading gear together with the shaft;

FIG. 7 is a perspective view of a massager in accordance with an embodiment, showing the state of the minimum distance between the first massage heads of the two groups of massage heads;

FIG. 8 is an illustration showing the state of the maximum distance between the first massage heads of the two groups of massage heads.

FIG. 9 is an illustration showing another embodiment illustrating the final product of a massage unit in accordance with an embodiment.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

Massagers promote blood circulation by vibrating or sudden movements, and relieve discomfort and stiffness caused by maintaining a fixed position for a long time, thus achieving the effect of relieving fatigue and effectively preventing disease. A common shoulder and neck massager includes a motor that drives the massage head to roll, rotate, or flip, pressing the desired area through a rotating massage action. However, for shoulder and neck massage, such massage is difficult to accomplish comfortably. There is a need for massagers that can produce comfort in a smaller range, such as a neck and shoulder.

Embodiments herein provide a shoulder and neck massager which can perform both shoulder massage and kneading, and increase the massage area and kneading stroke, so that the shoulder pressure is more comfortable.

In accordance with some embodiments, a neck and shoulder massage apparatus, includes at least two groups of massage heads arranged on a main body of the movement, each massage head group of the at least two groups includes a first massage head and a second massage head, the movement body includes the motor, the worm on the motor driven at both ends of the turbine, each turbine transmission including a kneading gear with a shaft, wherein the first massage head is arranged at the end of one connecting arm, the other end of the connecting arm is arranged on the shaft, and the connecting arm is provided with a strip attachment located on the main body of the movement, and the first massage head makes the composite motion of left and right swing and front and rear motion under the action of coupling arm rotation and attachment limit, and a the second massage head is fixed on the shaft, and when the kneading gear rotates, the second massage head is rotated with the kneading gear as the center, wherein the distance between the first massage head and the second massage head emulates a human thumb and fingers to enable a human hand type of massage; a cover coupled to the main body including at least two adjustable straps configured to accept human arms; and a buckle coupled to the at least two adjustable straps to enable lengthening and shortening of the at least two adjustable straps.

When the first massage head, limit nail, and second massage head are in a straight line, the first massage head and the second massage head alter between a maximum and minimum distance.

In some embodiments, when the first massage head and the second massage head are in a vertical angle state, the maximum or minimum distance between the first massage heads of the two groups of massage heads is achieved.

In some embodiments, the second massage head includes a rotating arm fixed to a shaft with at least one massage head attached to a rotating arm.

In some embodiments, the two groups of massage heads are symmetrically set, and the second massage heads in each of the two groups of massage heads are rotated in opposite directions.

In some embodiments, when the rotating arm and the connecting arm form a straight line, a maximum distance between the first massage head and the second massage head is achieved.

In some embodiments, when the rotating arm and the connecting arm overlap, a minimum distance is achieved between the first massage head and the second massage head.

In some embodiments, when the distance between the first massage head and the second massage head is greatest, the distance between the two first massage heads of the two groups of massage heads is the smallest, and when the distance between the first massage head and the second massage head is the smallest, the distance between the two first massage heads in the two groups of massage heads is the largest.

In some embodiments, when the rotating arm and the connecting arm are perpendicular, the maximum or minimum distance is formed between the first massage heads of the two groups of massage heads.

In accordance with some embodiments, the shoulder massage movement includes a kneading gear shaft to drive the second massage head rotation, the first massage head in the shaft and attachment as the fulcrum of the action of left and right swing, and front and rear movement of the composite movement, when the first massage head, limit nail, the second massage head are in a straight line. The distance between the first massage head and the second massage head is the maximum or minimum distance, and the effect of pinching between the two massage heads is realized, so that the massage head group can perform the massage and kneading of the shoulder at the same time, and there will be a change of distance between the first massage heads of the two groups of reciprocating movements to achieve a kneading effect. In some embodiments, the shoulder massager can satisfy the massage and kneading of the shoulder at the same time, and increases the kneading stroke, enhances the kneading effect, and has a more comfortable massage effect as a whole.

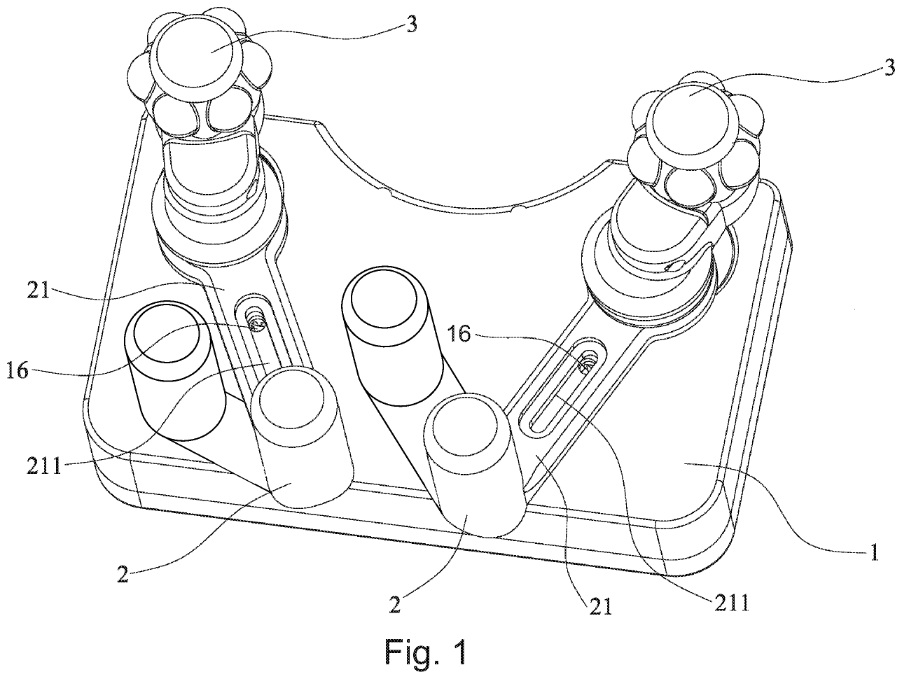

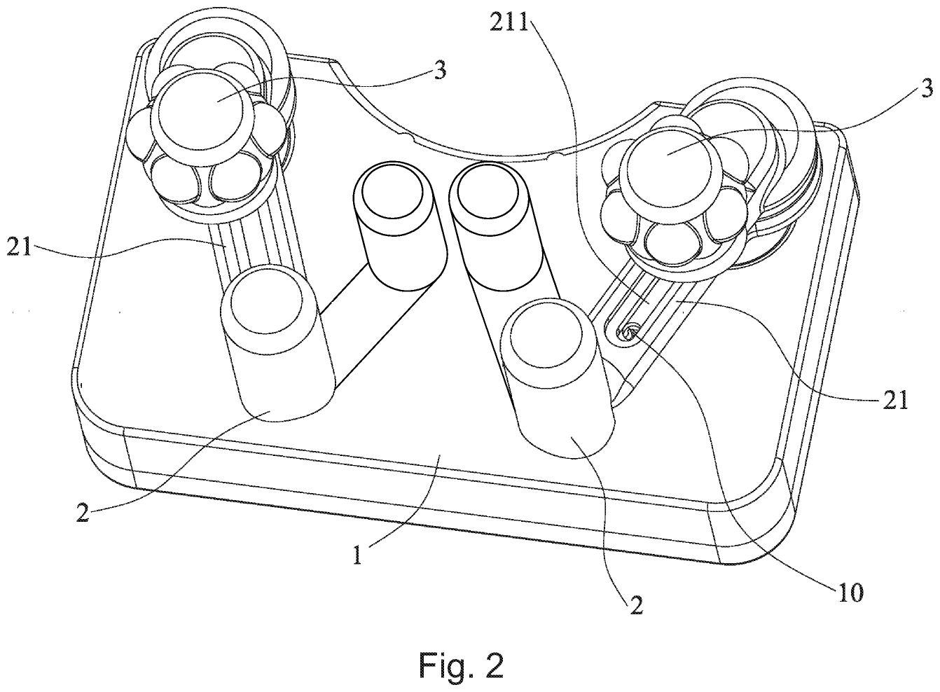

Referring now to FIGS. 1-4, a shoulder and neck massage movement in accordance with one or more embodiments includes two groups of massage heads arranged on the main body 1, two groups of massage heads can be symmetrical settings, each massage head group includes the first massage head 2, including on FIG. 1 and FIG. 2 a double massage head or two massage heads. As shown in FIG. 1, first massage head 2 and second massage head 3, and the main body of the movement is equipped with motor 11.

The torque of the motor 11 is driven by the worms 12 on the motor at both ends of the turbine 13, each turbine 13 drive a kneading gear 14, kneading gear 14 with a shaft 15, shaft 15 with kneading gear 14 rotation.

The first massage head 2 is arranged at the end of one connecting arm 21, and the other end sleeve of the connecting arm 21 is arranged on the axis 15. The connecting arm 21 is provided with a bar-shaped slider 211 limit is located on a set of attachment 16, shown in FIG. 1 on the main body of the movement, the attachment 16 through the slider 211, the connecting arm in the axis 15 rotation motion with the attachment 16 as the fulcrum, the movement stroke is limited by the limit position so that the first massage head 2 in the shaft 15 drives the connecting arm 21 rotation and attachment 16 limits under the action of left and right swing and front and rear movement of the composite movement, kneading massage.

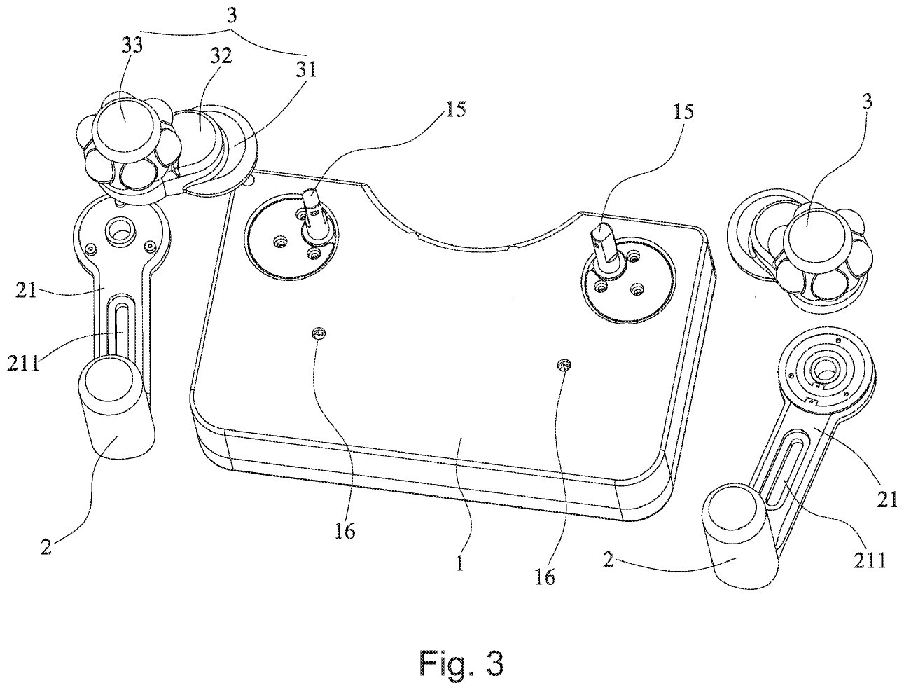

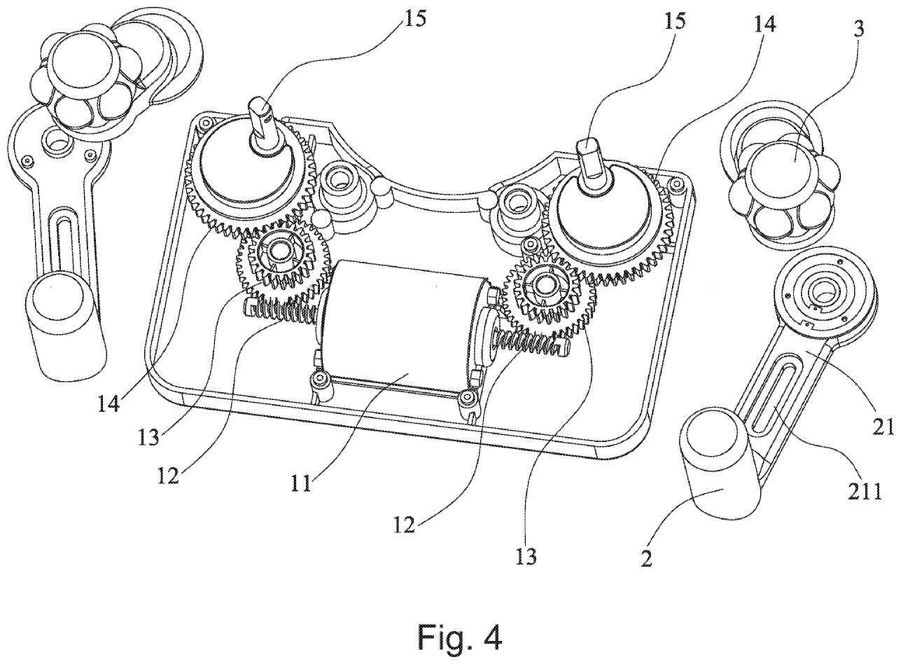

Referring to FIG. 3, the second massage head 3 is fixed on the shaft 15, when kneading gear 14 (shown in FIG. 4) rotation drives the second massage head 3 to knead the gear as the center of rotation, to achieve rotational movement. Worm wheel 13 and kneading gear meshing, the power to knead gear, the second massage head 3 in the axis 15 led by rotation, forming a kneading massage head. The second massage head 3 shown in FIG. 3, may include a cover plate 31 and a rotating arm connected to the cover plate 32, the rotating arm 32 fixed on the shaft 15, the rotating arm 32 is connected to at least one massage head 33, the cover plate 31, which is an active cover rotated on the end of the connecting arm 21, and the rotating arm 21 is driven by the shaft 15. The rotation of the massage action, and greatly increased the massage area and massage range, so that the rotation press is more comfortable.

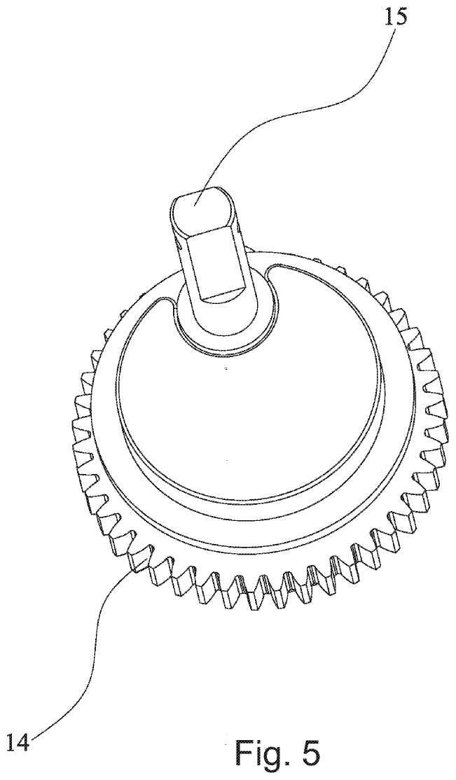

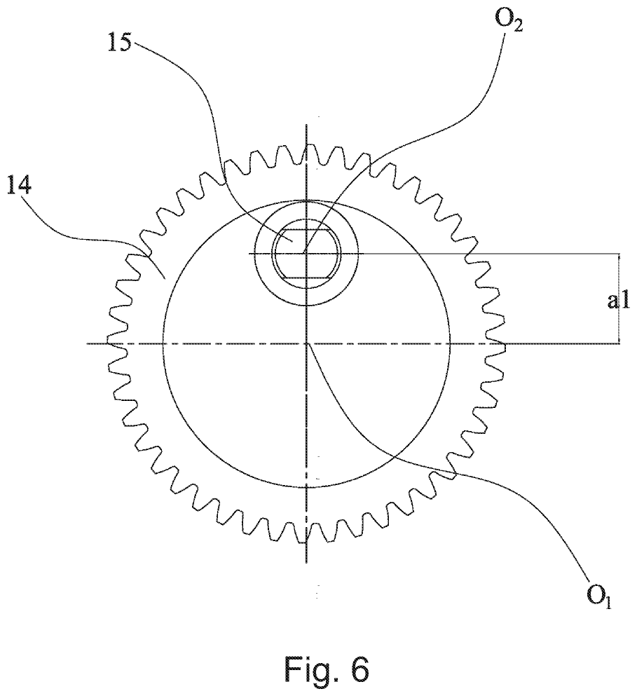

As shown in FIG. 5 and FIG. 6, the axis 15 is set on the kneading gear 14, the center of the axis 15, and the center O2 of kneading gear 14 form a certain distance between the central distance al between point O2 and point O1 shown in FIG. 6, thus making the shaft 15 drive the first massage heads 2 and the second massage heads 3 to achieve kneading.

Referring now to FIGS. 1 and 2, when the massage movement works, kneading gear 14 rotates the second massage heads 3 via axis 15 and drives the effect of rotation, and left and right two groups of massage heads in the second massage head 3 rotate. FIGS. 1 and 2 include first massage head group 2 showing two different massage heads, unlike FIGS. 3-4. In one embodiment, the two massage heads of first massage head 2 assists in enabling the human hand massage effect by emulating fingers while the first massage head 3 emulates a thumb.

In each group of massage heads, the first massage head (or heads) 2 in the connecting arm 21 are under the driving action of reciprocating rotation action because the sliding groove on the connecting arm 211 in the movement of the attachment 16 of the travel limit, so that the first massage head 2 in cooperation with attachment 16 as the pivot provide a left and right swing and front and rear movement of the composite movement. Both sides of the massage group 1 and 2 work at the same time, while satisfying the shoulder massage and kneading, massage can emulate a person's two hands opening and closing, kneading, pushing, and squeezing.

Referring back to FIG. 1, the second massage head 3 rotates above the first massage head 2 of the reciprocating movement when moving to the first massage head 2, attachment 16, second massage Head 3 in a straight line, that is, the rotating arm 32 (shown in FIG. 3) and the reciprocating moving connecting arm 21 form a straight line, the first massage head 2 and the second massage head 3 between the formation enable the shoulders to enter between the two massage heads.

Referring to FIG. 2, the rotation and reciprocating motion achieve the state shown. That is, when the rotating arm 32 and the reciprocating movement of the connecting arm 21 form a correlation, the first massage head 2 and the second massage head 3 between the formation of a minimum distance, so that the first massage head 2 and the second massage head 3 to achieve the effect of squeezing the shoulder.

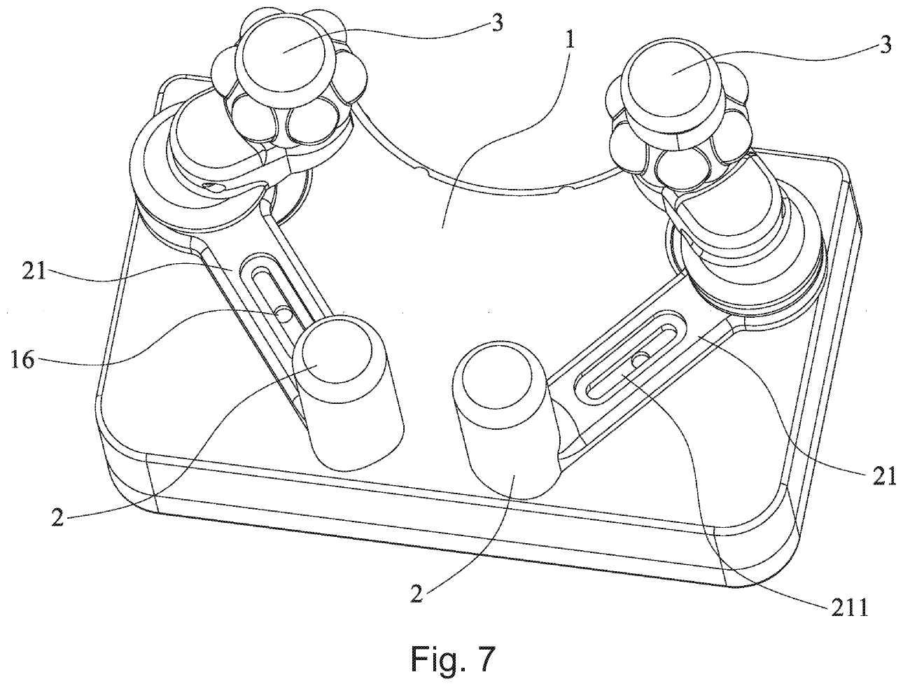

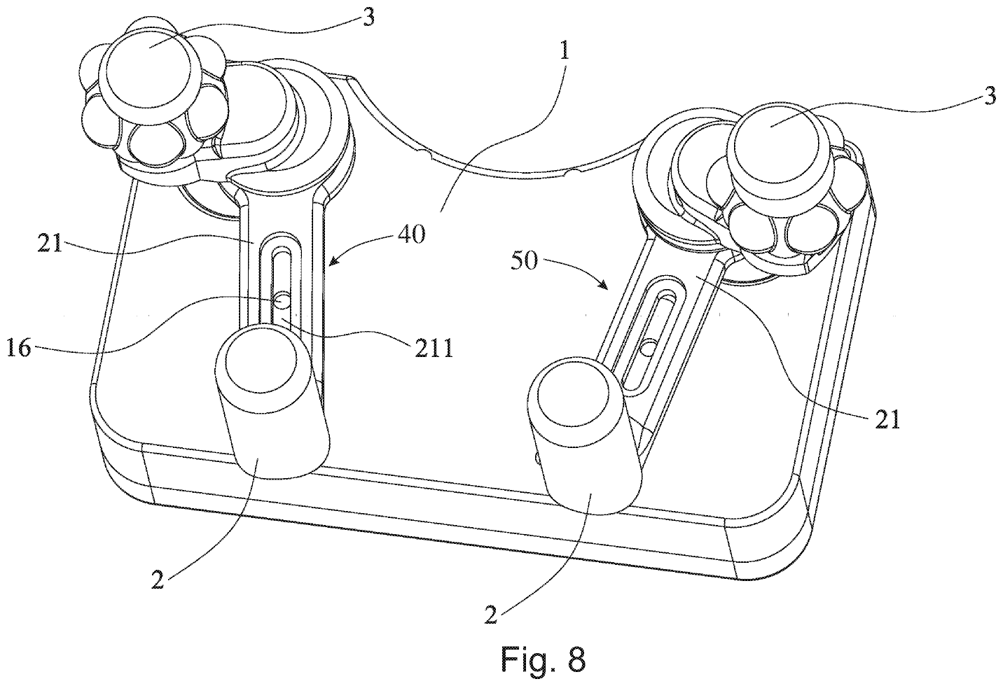

At the same time, the two groups located on the left and right sides of the massage head group between the distance between the first massage head 2 will also change, as shown in FIGS. 7 and 8, so that when the distance changes, the two groups of the first massage head 2 can also further achieve the effect of pinching, further in the middle of the kneading, increased massage area. When the first massage head 2 and the second massage head 3 are in the rotation of the vertical angle state, the two groups of massage heads, Group of the first massage head 2 between the formation of the maximum or minimum distance. As shown in the figure, when the rotation arm 32 and the connecting arm 21 are perpendicular, the maximum or minimum distance between the first massage head 2 of the two groups of massage heads is formed.

As shown in FIG. 7, that is, the reciprocating motion of the connecting arm 21 with the rotating arm 32, the connecting arm 21 from the inward motion to the outward movement, the attachment 16 is in the middle of the slider 211, and then the connecting arm 21 will drive the Chute 211 downward movement (attachment 16 relative to the slider upward activity), at this time. The first massage head 2 is perpendicular to the second massage head 3, while the distance between the first massage head 2 is minimal. Conversely, as shown in FIG. 8, when connecting arm 21 advances from outward motion to inward motion, the attachment 16 is in the middle of the chute 211. Next, the connecting arm drives the slider 211 upward (attachment 16 relative to the sliding groove downward activity), at which point the first massage head 2 is perpendicular to the second massage head 3, and the distance between the first massage heads identified as “2” is the largest.

The shoulder massage movement as described in embodiments includes a motor driving both sides of the kneading gear rotation. As shown in FIG. 4, kneading gear shaft 15 drives the second massage head 3 rotation, the first massage head 2 in the axis 15 and attachment as the fulcrum of the action of left and right and front and rear movement of the composite movement. When transferred to the first massage head, limit nail. When the second massage head is in a straight line, the distance between the first massage head and the second massage head will achieve a maximum or minimum distance. That is, each massage head 2 and each massage head 3 will work together so that the pair of massage head groups identified as group 40 and group 50, respectively, realizes the effect of squeezing, the two groups of reciprocating movement of the first massage head 2 will also have a distance change and achieve kneading effect. Embodiments can satisfy the massage and kneading of the shoulder at the same time, and increases the kneading stroke, enhances the kneading effect, and has a more comfortable massage effect as a whole.

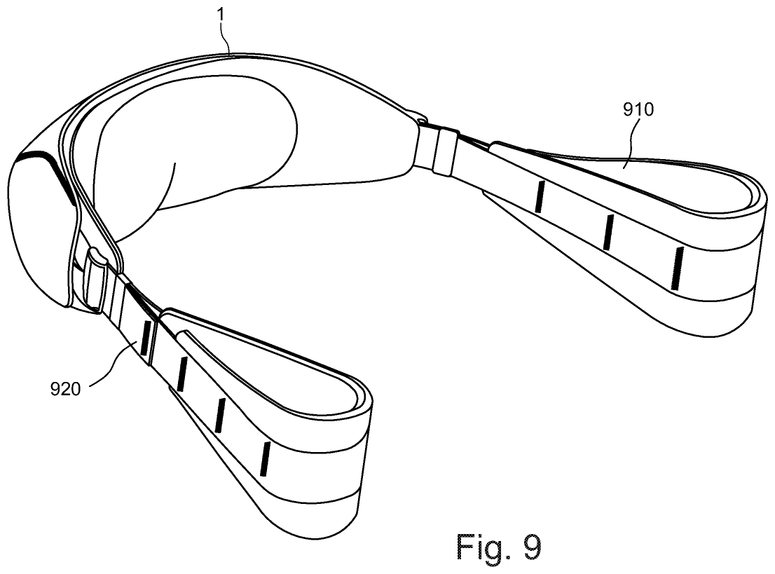

Referring now to FIG. 9, another embodiment illustrates final product of a massage unit in accordance with an embodiment.

As shown, main body 1 can be inserted into a cover that enables positioning via arm loops 910 for self-massage. The distance of arm loops 910 can be altered via buckle 920 located on the webbing of the arm loops 910.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following

What is claimed is:

1. A neck and shoulder massage apparatus, comprising:
at least two groups of massage heads arranged on a main body of the movement, each massage head group of the at least two groups includes a first massage head and a second massage head, the movement body includes the motor, the worm on the motor driven at both ends of the turbine, each turbine transmission including a kneading gear with a shaft, wherein the first massage head is arranged at the end of one connecting arm, the other end of the connecting arm is arranged on the shaft, and the connecting arm is provided with a strip attachment located on the main body of the movement, and the first massage head makes the composite motion of left and right swing and front and rear motion under the action of coupling arm rotation and attachment limit, and a the second massage head is fixed on the shaft, and when the kneading gear rotates, the second massage head is rotated with the kneading gear as the center, wherein the distance between the first massage head and the second massage head emulates a human thumb and fingers to enable a human hand type of massage;
a cover coupled to the main body including at least two adjustable straps configured to accept human arms; and
a buckle coupled to the at least two adjustable straps to enable lengthening and shortening of the at least two adjustable straps.

2. The neck and shoulder massage apparatus, as described in claim 1,
wherein the first massage head, limit nail, the second massage head in a straight line, the first massage head and the second massage head between the formation of the maximum or minimum distance: the neck and shoulder massage apparatus, as described in claim 1, wherein the first massage head and the second massage head are vertically angled, the maximum or minimum distance between the first massage heads of the two groups of massage heads is formed.

3. The neck and shoulder massage apparatus, as described in claim 3, wherein the second massage head includes a rotating arm fixed to the shaft, with at least one massage head attached to the rotating arm.

4. The neck and shoulder massage apparatus, as described in claim 4, wherein the symmetrical setting of the two groups of massage heads and the opposite direction of rotation of the second massage head in the two groups of massage heads.

5. The neck and shoulder massage apparatus, as described in claim 5, wherein the maximum distance between the first massage head and the second massage head is formed when the rotating arm and the connecting arm form a straight line.

6. The neck and shoulder massage apparatus, as described in claim 5, wherein the minimum distance between the first massage head and the second massage head is formed when the rotating arm and the connecting arm form a coincidence.

7. A neck and shoulder massage apparatus, as described in claim 5, wherein the formation of a maximum or minimum distance between the first massage heads of the two groups of massage heads when the rotating arm and the connecting arm are perpendicular.
